(19) United States
(12) Patent Application Publication
(10) Pub. No.: US 2008/0295012 A1
(43) Pub. Date: Nov. 27, 2008

(54) Drag-and-drop abstraction

(75) Inventors: David H. Sloo, Menlo Park, CA (US); Ronald A. Morris, San Francisco, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/805,306

(22) Filed: May 23, 2007

(51) Int. Cl. G06F 3/048

(52) U.S. Cl. 715/769

(57) ABSTRACT

Drag-and-drop abstraction is described. In embodiment(s), a graphical user interface displays destinations that can be selected to receive various media content, and also displays representations of the various media content. A user can associate a representation of the media content with one or more of the destinations. A resource manager can then determine a media format of a selected destination, as well as initiate delivery of an identifier of the media content to the selected destination.

### BACKGROUND

Today, people share and transfer files such as music, pictures, and video clips with each other and between their devices. For example, a computer user can attach a picture to an email message which is then communicated to a friend that can view the attached picture. In another example of file transfer, the computer user can “dock” an MP3 player to the computer and download music files for playback, or connect a combination PDA cell phone device to the computer to synchronize a calendar. These types of file transfers are between two direct-connected devices and the files are of a known format such that a receiving device can render or playback a transferred file.

### SUMMARY

This summary is provided to introduce simplified concepts of drag-and-drop abstraction. The simplified concepts are further described below in the Detailed Description. This summary is not intended to identify essential features of the claimed subject matter, nor is it intended for use in determining the scope of the claimed subject matter.

In embodiment(s) of drag-and-drop abstraction, a graphical user interface displays destinations that can be selected to receive various media content, and also displays representations of the various media content. A user can associate a representation of the media content with one or more of the destinations, such as with a drag-and-drop action that moves the representation of the media content over the display of a destination. A resource manager can then determine a media format of the selected destination, as well as initiate delivery of an identifier of the media content to the selected destination.

In other embodiment(s), a destination can be any entity or device that can receive and render media content in some media format. Further, the association of a representation of the media content with a selected destination can initiate the destination rendering the media content. For example, a television device can begin rendering a television program for viewing when a representation of the television media content is associated with a display of the television device on the graphical user interface. In other examples, a destination can be a portable device, a collection space or playlist that associates a collection of various selected media content, or a recipient that can them initiate a device to render the media content.

In other embodiment(s), the drag-and-drop action of a media content representation being associated with a destination is an allocation that can be independent of when and/or how the media content is rendered at the destination. Further, the allocation of the media content to the destination can be independent of where the specific media content is stored or from where the media content is obtained to be rendered at the destination. The media content can be delivered to a destination as an identifier that represents the media content such that the destination can then manage when and/or how to render the media content. The destination can also manage when and from where to obtain the media content.

### BRIEF DESCRIPTION OF THE DRAWINGS

Embodiments of drag-and-drop abstraction are described with reference to the following drawings. The same numbers are used throughout the drawings to reference like features and components:

FIG. 1 illustrates an example system in which embodiments of drag-and-drop abstraction can be implemented.

FIG. 2 illustrates another example system in which embodiments of drag-and-drop abstraction can be implemented.

FIG. 3 illustrates example method(s) for drag-and-drop abstraction in accordance with one or more embodiments.

FIG. 4 illustrates various components of an example computer device which can implement embodiments of drag-and-drop abstraction.

### DETAILED DESCRIPTION

Embodiments of drag-and-drop abstraction provide a graphical user interface that displays representations of media content and destinations such that a user can associate a media content representation with a destination to allocate the media content to the destination. The user can associate the media content representation with the destination with a drag-and-drop input of the media content representation over a display of the destination. For example, a picture-in-picture representation of a television program can be associated with a display of a television that represents a display device which can receive and render the television program for viewing. In other embodiments, any type of media content can be associated with various destinations, such as devices, recipients, or collection spaces.

The drag-and-drop action to allocate media content with a destination is a control mechanism to associate the media content with the destination. A realization of the drag-and-drop action can be independent of when and/or how the media content is rendered, as well as where the specific media content is stored or from where the media content is obtained by the destination. For example, the media content can be delivered to a destination as an identifier that represents the media content such that the destination can then manage when and/or how to render the media content. The destination can also manage when and from where to obtain the media content.

While features and concepts of the described systems and methods for drag-and-drop abstraction can be implemented in any number of different environments, computing systems, entertainment systems, and/or other various configurations, embodiments of drag-and-drop abstraction are described in the context of the following example systems and environments.

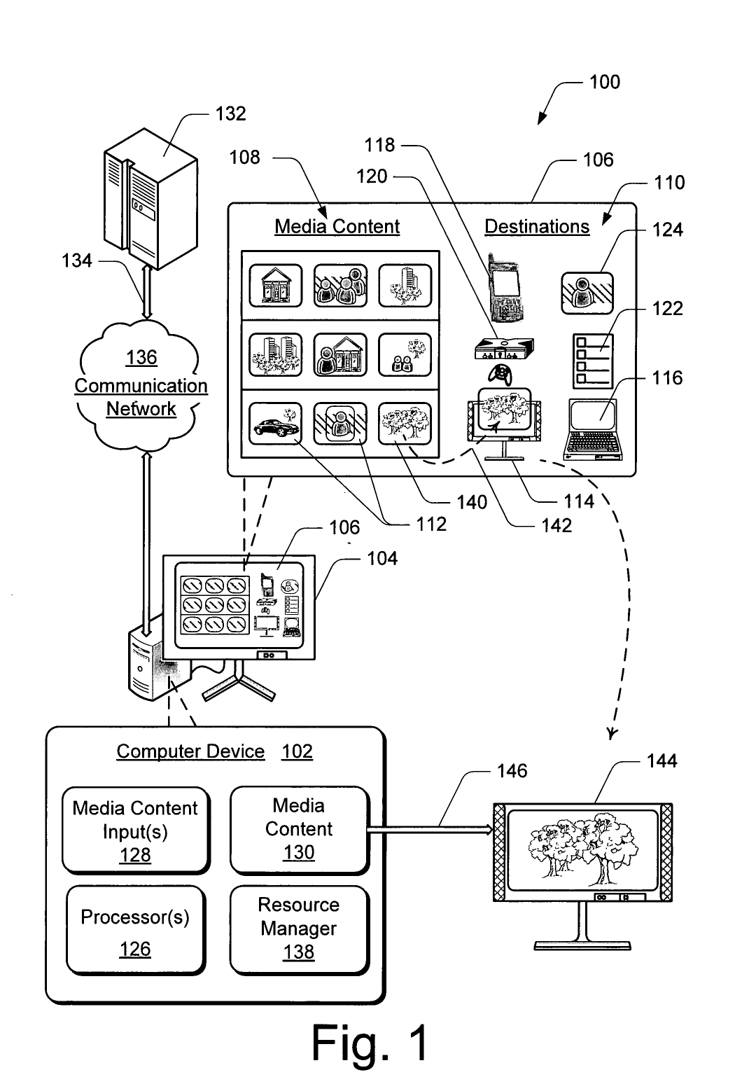

FIG. 1 illustrates an example system 100 in which various embodiments of drag-and-drop abstraction can be implemented. In this example, system 100 includes a computer device 102 and a display device 104 on which a graphical user interface 106 is displayed. In an embodiment of drag-and-drop abstraction, the graphical user interface 106 includes representations 108 of media content that are displayed proximate destinations 110 that can be selected to receive the media content. The media content representations 108 can be displayed as any one or combination of an identifier of the media content, an image of the media content, video of the media content, or as any other type of media content representation. In this example, the media content representations 108 are each displayed as a picture-in-picture 112 of television programming.

In various embodiments of drag-and-drop abstraction, a destination 110 can include any type of entity or device that can receive and render media content in some media format. In this example, the destinations 110 are displayed to include various devices such as a television display device 114, a portable computer 116, a PDA cell phone 118, a gaming system 120, and can also include any other type of electronic, appliance, and/or computing-based device. A destination 110 can also include various collection spaces such as a favorites collection, a buddy list, any type of group, or a playlist 122 (e.g., a “smart playlist”) that associates media content in a collection with other selected media content. A destination entity can also be an abstraction for personal preferences, a social group's ratings, or expert's recommendations for various media content. A destination 110 can also include an email address, a phone number, or a recipient 124 that can receive media content and initiate a device to render or playback the media content.

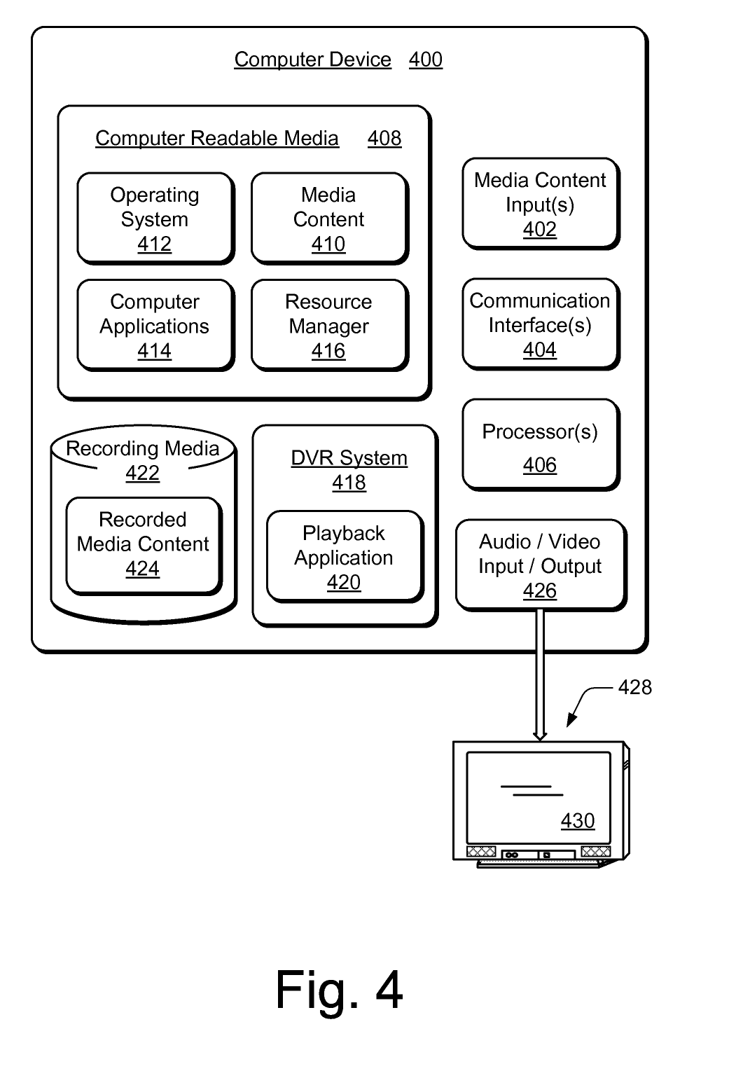

Computer device 102 can be implemented as any one or combination of a computer, television client device, an appliance device, a gaming console, and/or as any other type of computing-based device that may be implemented in a television entertainment and/or information system. Additionally, computer device 102 can be implemented with any number and combination of differing components as further described with reference to the example computer device shown in FIG. 4.

In this example system 100, computer device 102 includes one or more processor(s) 126, media content inputs 128, and media content 130 (e.g., received media content or media content that is being received). The media content inputs 128 can include any type of communication interfaces and/or data inputs, such as Internet Protocol (IP) inputs over which streams of media content (e.g., IPTV media content) are received. Computer device 102 can receive the media content 130 from any number of media content resources, such as a content distributor 132 via an IP-based network 134.

The media content 130 can include television programs (or programming) which may be any form of programs, commercials, music, movies, and video on-demand media content. Other media content can include interactive games, network-based applications, music streamed to the computer device 102, as well as any other audio, video, and/or image content received from any type of media content source. In addition, the media content 130 can be received to include television media content for a full-size television display as well as separate media streams of picture-in-picture media content received from the content distributor 132.

The IP-based network 134 can be implemented as part of a system communication network 136 that facilitates media content distribution and/or data communication between media content resources, the computer device 102, and any number of the destinations 110. The communication network 136 can be implemented as part of a media content distribution system using any type of network topology and/or communication protocol, and can be represented or otherwise implemented as a combination of two or more networks. The computer device 102 can be configured for communication with media content resources, such as the content distributor 132, via the IP-based network 134 and/or the communication network 136.

The computer device 102 also includes a resource manager 138 that can be implemented as computer-executable instructions and executed by the processor(s) 126 to implement embodiments of drag-and-drop abstraction. Although the resource manager 138 is illustrated and described as an independent application, the resource manager 138 can be implemented as several component applications or modules distributed to perform one or more functions of drag-and-drop abstraction.

In an example of drag-and-drop abstraction, a user can associate a representation 108 of the media content 130 with one or more of the destinations 110 on the graphical user interface 106. For example, the picture-in-picture representation 140 of the media content can be associated with a selected destination 114 by a drag-and-drop action 142 to allocate the media content for delivery to the selected destination. A user can drag-and-drop the media content representation 140 over the selected destination 114 with an input from a computer mouse, or other similar pointing device. The television media content (e.g., picture-in-picture 140) is associated with the destination 114 that is a representation of display device 144 which can be implemented as any type of television, LCD, or similar television-based display system that renders audio, video, and/or image data. In an embodiment, the drag-and-drop action 142 of the media content representation 140 initiates rendering the media content 130 at the selected destination display device 144.

Alternatively, the drag-and-drop action 142 to associate the picture-in-picture representation 140 of the media content with the selected destination 114 is a control mechanism to associate the media content with the destination display device 144. A realization of the drag-and-drop action can be independent of when and/or how the media content is rendered, as well as where the specific media content is stored or from where the media content is obtained by the destination. For example, an identifier of the media content can be delivered to the display device 144 such that the destination can then manage when and/or how to render the media content. The destination can also manage when and from where to obtain the media content, such as from the computer device 102 or from the content distributor 132.

In an embodiment, the resource manager 138 can be implemented to determine the media format of a selected destination when a media content representation 108 is associated with one or more of the destinations 110 on the graphical user interface 106. In addition, the resource manager 138 can then initiate rendering the media content at the selected destination(s) when the media content is delivered.

For example, the media content representation 140 on the graphical user interface 106 may be a graphic image that represents a television program. When the graphic image is associated with the representation of display device 144 on the graphical user interface 106, the resource manager 138 can then determine that the display device 144 renders media content in a television media format. Further, the resource manager 138 can initiate delivery 146 of the media content 130 to the display device 144 that renders the television program for viewing. In this example, a channel change of the television media content that is displayed on display device 144 can be initiated from the graphical user interface 106 by simply associating a different one of the media content representations 108 with the representation 140 of the display device.

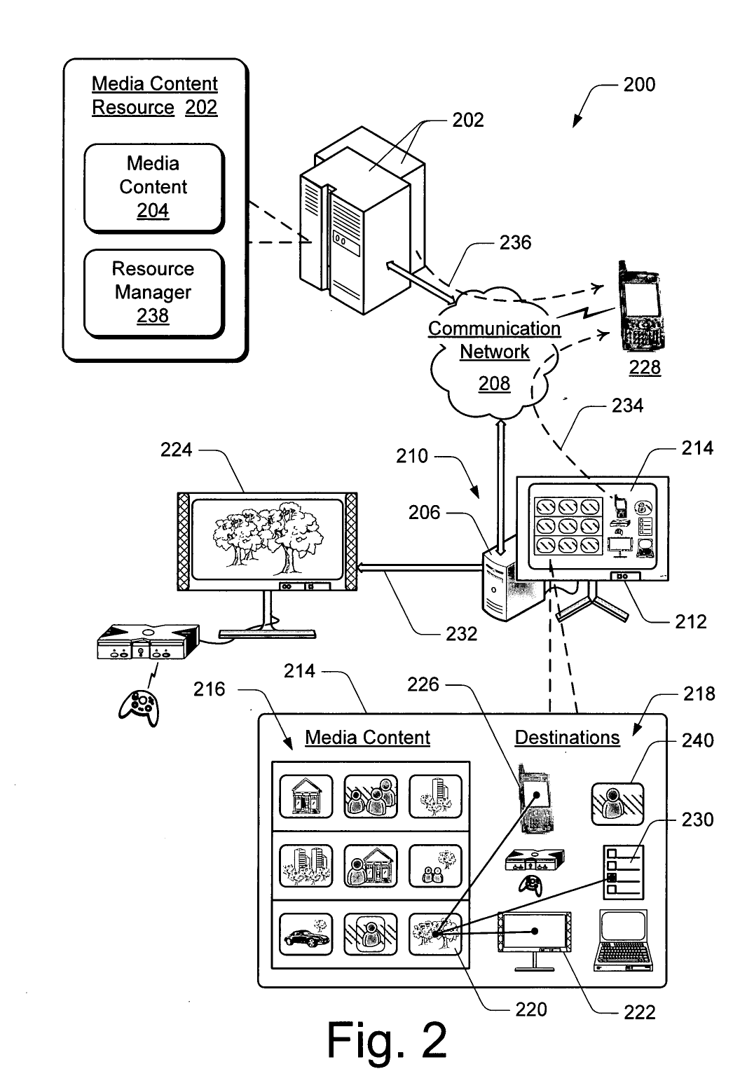

FIG. 2 illustrates another example system 200 in which various embodiments of drag-and-drop abstraction can be implemented. The system 200 includes media content resource(s) 202 that communicate media content 204 to any number of various client, computer, and/or computing-based devices, such as computer device 206 via a communication network 208. An example of a communication network is described with reference to communication network 136 shown in FIG. 1. The communication network 208 can be implemented to include an IP-based network that facilitates media content distribution and data communication between the media content resource(s) 202 and any number of client and/or computer devices.

The computer device 206 can be implemented with one or more processors, a communication module, memory components, a media content rendering system, and a resource manager to implement embodiments of drag-and-drop abstraction. An example of a resource manager is described with reference to resource manager 138 shown in FIG. 1. Additionally, the computer device 206 can be configured for communication with any number of different media content resources 202 to receive any type and format of media content 204 via the communication network 208.

In this example, a computer system 210 includes the computer device 206 and a display device 212 on which a graphical user interface 214 is displayed. The graphical user interface 214 includes representations 216 of the media content 204 that are displayed proximate destinations 218 which can be selected to receive the media content. In an embodiment of drag-and-drop abstraction, a user can associate a media content representation 220 with one or more of the destinations 218 on the graphical user interface 214.

For example, the picture-in-picture representation 220 of a television program is associated with selected destination 222 which is a representation of display device 224 that can be any type of television, LCD, or similar television-based display system that renders audio, video, and/or image data. In an embodiment, associating the media content representation 220 with the destination 222 initiates rendering the media content 204 at display device 224. The media content representation 220 is also associated with a selected destination 226 that is a representation of a cell phone device 228, and is also associated with a selected destination 230 that is a representation of a playlist.

In an embodiment, a resource manager at computer device 206 can be implemented to determine the media format of the selected destinations when the media content representation 220 is associated with the selected destinations on the graphical user interface 214. In addition, the resource manager 138 can then initiate rendering the media content at the selected destinations when the media content is delivered. In this example, the selected destinations associated with the media content may each render a different media format of the media content.

The media content representation 220 on the graphical user interface 214 may be a picture-in-picture that represents a television program. When the picture-in-picture representation 220 is associated on the graphical user interface 214 with the representation of display device 224, the resource manager can then determine that the display device 224 renders media content in a television media format. Further, the resource manager can initiate delivery 232 of the media content 204 to the display device 224 that renders the selected television program for viewing.

The resource manager (e.g., at computer device 206) can also determine that the cell phone device 228 renders media content in a still image format. The resource manager can then redirect 234 the allocation of the media content for delivery 236 of the media content 204 to the cell phone 228 from a media content resource 202. Unlike a simple file transfer to a “docked” device, the resource manager can initiate delivery of media content to a destination where the media content is delivered from a media content resource other than where the resource manager is implemented. In this example, a different bit of the media content is delivered to the cell phone device 228 other than the specific item of media content that is selected. In addition, a media content resource 202 can have or maintain different formats of the various media content for delivery to one or more of the destinations 218. In an alternate embodiment of example system 200, a media content resource 202 can include a resource manager 238 rather than, or in addition to, a resource manager at computer device 206 to implement embodiments of drag-and-drop abstraction.

The resource manager at computer device 206 can also initiate delivery of an identifier that represents the media content to a selected destination, such as the playlist 230. In an example, the media content representation 220 may be of a television program that is scheduled for a future broadcast, in which case an identifier of the media content is added to the playlist 230 such that when the television program is broadcast, it can be rendered for viewing on display device 224. Similarly, if the destination 240 that represents a recipient is associated with a media content representation 216, the resource manager can initiate delivery of the media content to the recipient with an identifier that represents the media content. A recipient can then initiate the identifier, which may be a link to a Web site or to another device, to render or playback the media content.

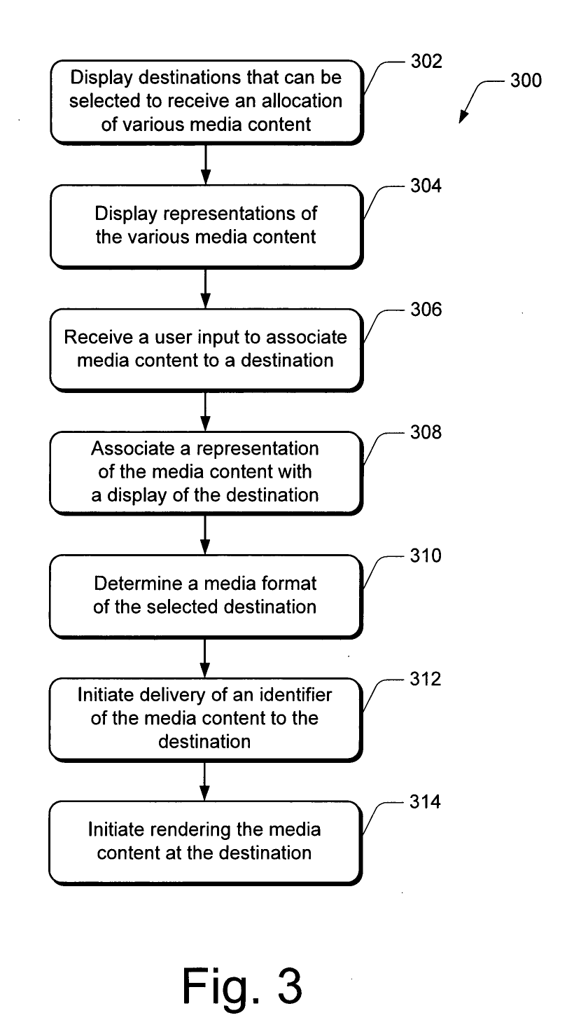

Generally, any of the functions, methods, and modules described herein can be implemented using hardware, software, firmware (e.g., fixed logic circuitry), manual processing, or any combination thereof. A software implementation of a function, method, or module represents program code that performs specified tasks when executed on a computing-based processor. Example method 300 described with reference to FIG. 3 may be described in the general context of computer-executable instructions. Generally, computer-executable instructions can include applications, routines, programs, objects, components, data structures, procedures, modules, functions, and the like that perform particular functions or implement particular abstract data types. The method(s) may also be practiced in a distributed computing environment where functions are performed by remote processing devices that are linked through a communications network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 of drag-and-drop abstraction. The order in which the method is described is not intended to be construed as a limitation, and any number of the described method blocks can be combined in any order to implement the method, or an alternate method.

At block 302, destinations are displayed that can be selected to receive an allocation of various media content. At block 304, representations of the various media content are displayed. For example, graphical user interface 106 (FIG. 1) includes representations 108 of media content that are displayed proximate destinations 110 which can be selected to receive the media content. The media content representations 108 can be displayed as any one or combination of an identifier of the media content, an image of the media content, video of the media content, or as any other type of media content representation.

At block 306, a user input is received to associate media content with a destination and, at block 308, a representation of the media content is associated with a display of the destination. For example, a user input is received as a drag-and-drop action 142 on graphical user interface 106 to associate the picture-in-picture representation 140 with the selected destination 114 to allocate the media content for delivery to display device 144 which is represented by the selected destination 114. In an embodiment, the drag-and-drop action of a representation of the media content with a display of a destination is a control mechanism to associate the media content with the destination. A realization of the drag-and-drop action can be independent of when and/or how the media content is rendered, as well as where the specific media content is stored or from where the media content is obtained.

At block 310, a media format of the selected destination is optionally determined. For example, the resource manager 138 of computer device 102 determines the media format of a selected destination when a media content representation 108 is associated with one or more of the destinations 110 on the graphical user interface 106. In the example of the television display device 144, the resource manager 138 determines that the display device 144 renders media content in a television media format.

At block 312, an identifier of the media content is initiated for delivery to the destination. For example, the media content can be delivered to a destination as an identifier (or as an “abstraction”) that represents the media content such that the destination can then manage when and/or how to render the media content. The destination can also manage when and from where to obtain the media content. A destination “rendering” the media content, or a rendering action, can include television device 224 obtaining a high-definition version of the selected media content from a media content resource 202 (rather than from an initiating device 206). For a destination that is the cellular phone 214, rendering can include sending an MMS (Multimedia Messaging Service) message containing a clip of the start of the content, which is stored locally at the computer device 206 where the graphical user interface 214 appears, but down-sampled to QVGA (Quarter Video Graphics Array) resolution. In another example, the resource manager 138 initiates delivery 146 of the media content 130, or other media content from content distributor 132, to the display device 144 that renders the television program for viewing.

At block 314, optionally, the media content is initiated to be rendered at the destination. For example, the resource manager 138 can initiate rendering the media content at the selected destination(s) when the media content is delivered. In the example of the television display device 144, the media content 130 is delivered to the display device 144 and that action can initiate the display device 144 to render or playback the media content for viewing.

FIG. 4 illustrates various components of an example computer device 400 that can be implemented as any form of a computing, electronic, or television client device to implement embodiments of drag-and-drop abstraction. For example, computer device 400 can be implemented as computer device 102 shown in FIG. 1. In various embodiments, computer device 400 can be implemented as any one or combination of a television client device, a desktop computer, a portable computer, an appliance device, a gaming console, and/or as any other type of computing-based device.

Computer device 400 includes one or more media content inputs 402 that may include Internet Protocol (IP) inputs over which streams of media content are received via an IP-based network. Computer device 400 further includes communication interface(s) 404 that can be implemented as any one or more of a serial and/or parallel interface, a wireless interface, any type of network interface, a modem, and as any other type of communication interface. A network interface provides a connection between computer device 400 and a communication network by which other electronic and computing devices can communicate data with device 400. Similarly, a serial and/or parallel interface provides for data communication directly between computer device 400 and the other electronic or computing devices. A modem facilitates computer device 400 communication with other electronic and computing devices via a conventional telephone line, a DSL connection, cable, and/or other type of connection.

Computer device 400 also includes one or more processors 406 (e.g., any of microprocessors, controllers, and the like) which process various computer-executable instructions to control the operation of device 400, to communicate with other electronic and computing devices, and to implement embodiments of drag-and-drop abstraction. Computer device 400 can be implemented with computer-readable media 408, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer-readable media 408 provides data storage mechanisms to store media content 410 as well as other information and/or data such as software applications and any other types of information and data related to operational aspects of computer device 400. For example, an operating system 412 and/or other computer applications 414 can be maintained as software applications with the computer-readable media 408 and executed on processor(s) 406 to implement embodiments of drag-and-drop abstraction. Computer device 400 can also include a resource manager 416 (shown as a software module in this example) to implement various embodiments of drag-and-drop abstraction as described herein. Examples of the resource manager 416 are described with reference to resource manager 138 in computer device 102 shown in FIG. 1.

When implemented as a television client device, the computer device 400 can also include a DVR system 418 with playback application 420, and recording media 422 to maintain recorded media content 424 that computer device 400 receives and/or records. Further, computer device 400 may access or receive additional recorded media content that is maintained with a remote data store (not shown). Computer device 400 may also receive media content from a video-on-demand server, or media content that is maintained at a broadcast center or content distributor that distributes the media content to subscriber sites and client devices. The playback application 420 can be implemented as a video control application to control the playback of media content 410, the recorded media content 424, and/or other video on-demand media content, music, and any other audio, video, and/or image media content which can be rendered and/or displayed for viewing.

Computer device 400 also includes an audio and/or video output 426 that provides audio and/or video data to an audio rendering and/or display system 428. The audio rendering and/or display system 428 can include any devices that process, display, and/or otherwise render audio, video, and image data. Video signals and audio signals can be communicated from computer device 400 to a display device 430 via an RF (radio frequency) link, S-video link, composite video link, component video link, DVI (digital video interface), analog audio connection, or other similar communication link. Alternatively, the audio rendering and/or display system 428 can be implemented as integrated components of the example computer device 400.

Although embodiments of drag-and-drop abstraction have been described in language specific to features and/or methods, it is to be understood that the subject of the appended claims is not necessarily limited to the specific features or methods described. Rather, the specific features and methods are disclosed as example implementations of drag-and-drop abstraction.

1. A method, comprising:
receiving a user input to associate media content with a destination when a media content representation is associated with a display of the destination;
determining a media format of the destination when the media content representation is associated with the display of the destination; and
initiating delivery of an identifier of the media content to the destination.

2. A method as recited in claim 1, further comprising displaying the destination proximate one or more media content representations on a graphical user interface, and wherein the user input is received as a drag-and-drop of the media content representation over the display of the destination.

3. A method as recited in claim 2, further comprising displaying each of the media content representations as a picture-in-picture of television media content.

4. A method as recited in claim 1, further comprising delivering the media content to the destination in the media format of the destination.

5. A method as recited in claim 1, further comprising initiating rendering the media content at the destination when the media content representation is associated with the display of the destination.

6. A method as recited in claim 1, wherein the media content is further delivered to the destination in one or more different formats of the media content.

7. A media content system, comprising:
a graphical user interface configured to:
display one or more destinations that can be selected to receive media content;
display one or more media content representations such that a user can associate a media content representation with one or more of the destinations; and
a resource manager configured to determine a media format of a selected destination and initiate delivery of an identifier of the media content to the selected destination.

8. A media content system as recited in claim 1, wherein the media content representation can be associated with the selected destination by a drag-and-drop to allocate the media content for delivery to the selected destination.

9. A media content system as recited in claim 8, wherein the drag-and-drop allocation of the media content initiates rendering the media content at the selected destination.

10. A media content system as recited in claim 1, wherein the one or more destinations are displayed such that the user can associate the media content representation for delivery of the media content to each of the destinations.

11. A media content system as recited in claim 1, wherein the resource manager is further configured to determine a different media format of an additional destination and initiate delivery of the media content in the different media format to the additional destination.

12. A media content system as recited in claim 1, wherein the resource manager is further configured to initiate delivery of the media content in the media format to the selected destination.

13. A media content system as recited in claim 1, further comprising a media content resource configured to maintain different formats of the various media content, and wherein the resource manager is further configured to initiate the delivery of the media content to the selected destination from the media content resource as one or more different formats of the media content.

14. A media content system as recited in claim 1, wherein the one or more media content representations are each displayed on the graphical user interface as a picture-in-picture of television media content.

15. A media content system as recited in claim 1, wherein the one or more media content representations are each displayed on the graphical user interface as at least one of an identifier of the media content, an image of the media content, or video of the media content.

16. A media content system as recited in claim 1, wherein the selected destination is a collection space configured to associate the media content in a collection with other selected media content.

17. A media content system as recited in claim 1, wherein the selected destination is a recipient of the media content, and wherein the recipient can initiate a device to render the media content.

18. Computer-readable media encoded with computer-executable instructions that, when executed, display a graphical user interface, comprising:
one or more destinations that can be selected to receive an allocation of various media content; and
one or more representations of the various media content such that a user can associate a media content representation with a destination that receives an allocation of the media content.

19. Computer-readable media as recited in claim 18, further encoded with computer-executable instructions that, when executed, receives a user drag-and-drop input to move the media content representation over the display of the destination to allocate the media content to the destination.

20. Computer-readable media as recited in claim 18, further encoded with computer-executable instructions that, when executed, initiates a resource manager to determine a media format of the destination and initiate delivery of the media content in the media format to the destination.
